(19) United States
(12) Patent Application Publication
(10) Pub. No.: US 2009/0248966 A1
(43) Pub. Date: Oct. 1, 2009

(54) FLASH DRIVE WITH USER UPGRADEABLE CAPACITY VIA REMOVABLE FLASH

(76) Inventor: Jeffrey L. Crandell, Hermosa Beach, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/404,799

(22) Filed: Mar. 16, 2009

Related U.S. Application Data
(60) Provisional application No. 61/039,128, filed on Mar. 25, 2008.

(51) Int. Cl. G06F 12/00; G06F 13/00; G06F 12/02; G06F 12/14

(52) U.S. Cl. 711/103; 710/301; 711/115; 707/202; 707/E17.01; 711/E12.001; 711/E12.008; 711/173; 711/164

(57) ABSTRACT

An exemplary data storage device includes a fixed storage medium, an expansion socket configured to selectively receive at least one removable memory card, and a controller configured to interface the fixed storage medium and the at least one removable memory card with a host device. An exemplary method includes verifying credentials with verification data stored on the fixed storage medium of the data storage unit, and protecting data on the removable storage medium removably attached to the data storage unit.

### CROSS-REFERENCE TO RELATED APPLICATIONS

This application claims the benefit of application Ser. No. 61/039,128 filed on Mar. 25, 2008, the contents of which are incorporated herein in their entirety.

### TECHNICAL FIELD

The present disclosure relates to data storage units, and more particularly to a flash media storage device including a flash media expansion socket.

### BACKGROUND

Flash memory devices, and Universal Serial Bus (USB) based flash memory drives are commonly used for storing digital data, media, and files. USB drives generally combine flash memory with a USB connector allowing the drive to be selectively associated and disassociated with a host device such as a computer. USB drives are popular in part due to their small form factor, durability, and near ubiquitous compatibility.

USB drives include a quantity of memory that remains fixed for the life of the device. However, data storage needs generally increase over time. Moreover, the popularity of digital media such as digital pictures, music, and videos has greatly expanded the need for digital storage space. As with many other forms of technology, each new generation of flash memory generally provides greater storage space at roughly equivalent price points to previous generations. Accordingly, flash memory on a cost per quantity basis generally decreases over time.

The small form factor, durability, and near ubiquitous compatibility of USB drives that make them popular also further their use in mobile or portable applications. However, because portable USB drives can be easily misplaced and lost, they present security issues for data stored thereon.

### BRIEF DESCRIPTION OF THE DRAWINGS

Exemplary illustrations of the disclosure will now be described with reference to the accompanying drawings, wherein:

FIG. 1A is a system diagram including a partial view of an exemplary data storage unit including an expansion socket and a removable flash memory card;

FIG. 1B is a perspective view of the elements of FIG. 1A;

FIG. 2A is a perspective view of another exemplary data storage unit attached to a host computer;

FIG. 2B is a top view of the device of FIG. 2A;

FIG. 3 is a flowchart including steps and decisions of an exemplary method of securing data; and

FIG. 4 is a flowchart including steps and decisions of an exemplary method for accessing secured data.

### DETAILED DESCRIPTION

Exemplary illustrations of a data storage unit with user upgradeable capacity are described below. In the interest of clarity, not all features of an actual implementation are described in this specification. It will of course be appreciated that in the development of any such actual illustration, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

Referring now to the drawings wherein like numerals indicate like or corresponding parts throughout the several views, exemplary embodiments are illustrated.

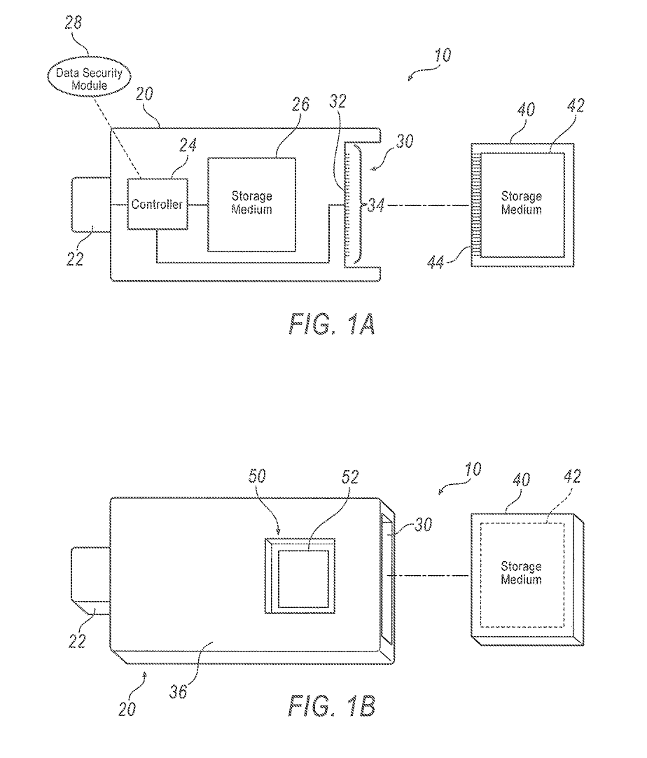

FIGS. 1A and 1B illustrates a system 10 including an exemplary data storage unit 20. The data storage unit 20 maintains the convenience provided by portable and durable storage devices, addresses the ever increasing need for storage space, and takes advantage of the decreasing cost of flash memory. The storage unit 20 includes a connector 22 for physically coupling with a host device (not show). The connector 22 may be designed according to a standardized peripheral communication protocol and physical form factor, such as Universal Serial Bus (USB). The connector 22 may be attached to a printed circuit board (not show). The printed circuit board may also include a controller 24 and a fixed storage medium 26. Wires for interconnecting and powering the connector 22, controller 24, and fixed storage medium 26, as well as other incidental circuitry (not show), may be provided on the printed circuit board. A data security module 28 may be provided by the controller 24 for securing data.

A slot 30 in an external casing 36 (see FIG. 1B) of the data storage unit may house a socket 32 with leads 34 to receive a removable flash media card 40 including a second storage medium 42. Accordingly, the second storage medium 42 may be a removable storage medium relative to the fixed storage medium 26 and the data storage unit 20. The socket 32 may be attached to the printed circuit board and may be connected to the controller 24. As illustrated in FIG. 1B, a biometric reader 50 including a fingerprint scanner 52 may be provided on the casing 36. The biometric reader 50 may be operated by the controller 24 when implementing the data security module 28.

The data storage unit 20 may be any general purpose or specialty storage device capable of interfacing the host device with the storage mediums 26, 42. The connection between the data storage unit 20 and the host device may be a data transmission bus. The host device may include a host controller (not show) that connects via the bus to the controller 24. The controller 24 in cooperation with the host device may regulate the storage and retrieval of data to and from the storage mediums 26, 42. The storage mediums 26, 42 may include magnetic disks or solid state devices including flash memory. In one exemplary approach, the flash memory may include NAND based electrically erasable programmable read-only memory (EEPROM).

In one exemplary approach, the data storage unit 20 may be a USB device. In such an approach, the connector 22 may be a USB connector, and the controller 24 may implement the USB protocol. In particular, the controller 24 may include a general purpose processor that implements the USB mass storage device class. The USB mass storage device class may present a generic block-structured device to the host operating system, thereby hiding the individual and complex implementation details of the various underlying flash memory technologies of the storage mediums 26, 42. Implementing the USB mass storage device class may allow many operating systems to read and write to the storage mediums 26, 42 without any additional device drivers. Once the storage medium 26 is presented as a generic block device, it may be formatted with a particular file system by the host device.

The controller 24 may be customized to also interface with the socket 32 and the removable storage medium 42. As noted above, the removable storage medium 42 may be provided by a removable flash memory card 40. The socket 32 may be configured to interface with any of the standardized forms of flash memory cards including CompactFlash, MemoryStick, Secure Digital, xD, etc. A removable flash memory card 40 may include contacts 44 for connecting with the leads 34 of the socket 32. In one exemplary approach, the socket 32 may be configured for only a single flash memory card 40 standard. However, other exemplary approaches may include multiple sets of leads 34 to connect with a plurality of memory cards 40 standards. When a memory card 40 is attached to the socket 32, the controller 24 may present the second storage medium 42 as generic block device to the host device. In one exemplary approach, the storage mediums 26, 42 may be presented as separate drives to the host device. However, in another exemplary approach, the storage mediums 26, 42 may be presented as a single drive.

The controller 24 may be configured to selectively present the storage mediums 26, 42 as drives to the host device. The data security module 28 may include instructions for determining whether the storage mediums 26, 42 should be presented to the host device. In one exemplary approach, both storage mediums 26, 42 may be secured by the data security module 28. However, in other exemplary approaches, only one of the storage mediums 26, 42 may be secured by the data security module 28. For example, the fixed storage medium 26 may always be presented to the host device while the removable storage medium 42 may be subjected to the data security module 28.

The data security module 28 may implement multiple techniques to secure data on the storage medium 42. For example, the data security module 28 may provide one or more encryption algorithms. The encryption algorithms may be used to encrypt individual files or the entire storage medium 42. In another exemplary data security technique, the controller 24 may interfere with the ability of the host device to use the storage medium 42 according to one or more partition protection techniques. In one exemplary partition protection technique, the controller 24 may only allow read access to the storage medium 42 by preventing data from being written thereto. In another exemplary partition protection technique, the controller 24 may completely hide the existence of the storage medium 42 from the operating system of the host device.

Other partition protection techniques could affect the file system of the storage medium 42. As noted above, the operating system of the host device may format the storage medium with a particular file system (e.g. FAT32). The file system generally overlays the storage medium 42 with a logical organization scheme. The controller 24 simply provides random access to the storage medium 42 and therefore may be agnostic with respect to the file system. Accordingly, the controller 24 may be configured to selectively corrupt and restore the file system of the storage medium 42 as another exemplary partition protection technique. For example, the controller 24 may reversibly corrupt a critical area of the storage medium 42 used by the file system such as the master boot record, file table, etc. Such a corruption could render the storage medium 42 unusable by the operating system of the host device. However, because the file system is irrelevant to the controller 24, any alterations or corruption thereto will not affect the ability of the controller 24 to access the data of the storage medium 42. Accordingly, the controller 24 can be used to selectively restore the file system to a functional state.

The controller 24 as configured by the data security module 28 may implement the above encryption and partition protection techniques with the assistance of the fixed storage medium 26. For example, information needed to recover a reversible corrupted file system could be stored on the fixed storage medium 26. Similarly, decryption keys and credential verification data could be stored on the fixed storage medium 26. By storing the decryption and recovery information on the fixed storage medium 26, the portability of the data storage unit 20 may be maintained. However, in another exemplary approach, the decryption keys and recovery information may be stored on the host device if the storage unit 20 does not need to be used with other host devices. The data storage unit 20 may be configured to secure data on a plurality of removable flash memory cards 40. Each removable flash memory card 40 may be configured with different decryption keys and recovery information. Accordingly, the fixed storage medium 26 may store and organize the decryption keys and recovery information for the plurality of removable flash memory cards 40.

The data security module 28 may implement a credentialing technique to verify the identity of an operator. Reversing the partition protection and decrypting the storage medium 42 may trigger the credentialing technique. However, to reduce the likelihood that data is inappropriately or inadvertently secured, the data security module 64 may also require credentialing prior to encryption and partition protection. There may be many possible types of credentialing techniques including digital certificates, password generating tokens and even simple password access. In one exemplary approach, the credentialing technique may rely on the biometric reader 50. In general, biometric readers 50 may be available for determining different biometric attributes including fingerprints, palm prints, retina patters, facial shapes, voice signatures, etc. The fingerprint scanner 52 of the biometric reader may be used to read an initial fingerprint scan as well was subsequent fingerprint scans. The data security module 28 may create a template from the initial fingerprint scan. The template may be stored on the fixed storage medium 26 for verifying subsequent fingerprint scans. In order to protect the actual fingerprint scans, the template may be stored as a derivative of the initial scan. Similarly, the subsequent scan may be converted to a corresponding derivative for comparison to the template.

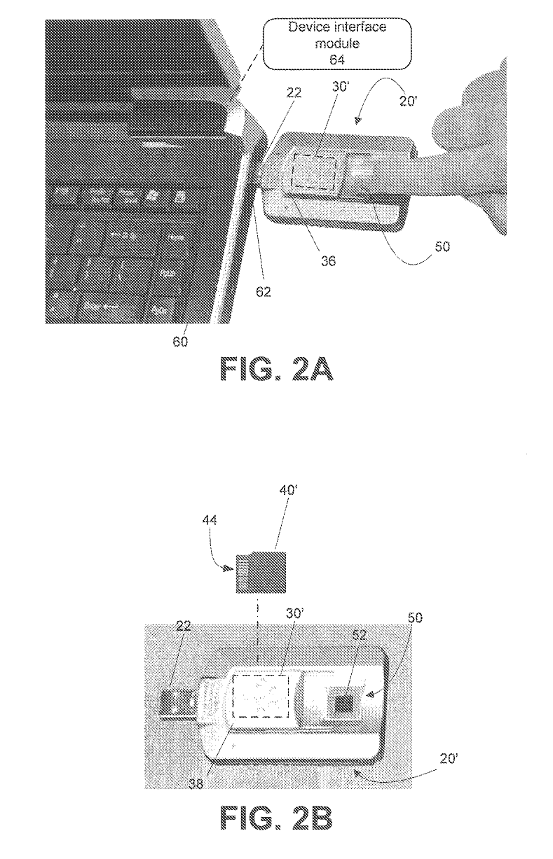

FIG. 2A illustrates another exemplary data storage unit 20′ that is upgradeable with removable flash memory. As illustrated, the data storage unit 20′ may be coupled with a host device 60. For example, the connector 22 may be inserted into a port 62 provided by the host device 60. The data storage unit 20′ may include the same elements discussed above with respect to FIGS. 1A and 1B even if not explicitly depicted. For example, the data storage unit 20′ may include the controller 24 and fixed storage medium 26 discussed above. The host device 60 may include software instructions such as a device interface module 64 to take advantage of the data security techniques discussed above. A copy of the device interface module 64 may be stored on an unsecured portion of the fixed storage medium 26 to facilitate the portability and interoperability of the data storage unit 20′. For example, if the data storage unit 20′ is connected to a host device 60 that does not include the device interface module 64, the host device 60 may retrieve the device interface module 64 from the fixed storage medium 26. The device interface module 64 may provide a graphical user interface to access and control the data security techniques provided by the data security module 28. For example, the device interface module 64 may allow an operator to choose whether to use a particular data security technique, or a combination thereof.

The data storage unit 20′ may accept a removable flash memory card 40′ (FIG. 2B). However, rather than inserting the card 40′ into a slot 30 (FIG. 1A), the data storage unit 20′ may include a compartment 30′ with a slideably disposed cover 38. The compartment may include a socket and leads (not show) for interfacing with the contacts 44 of the memory card 40′. Once inserted, the memory card 40′ may be enclosed within the compartment 30′ by the cover 38. The cover 38 may also protect the biometric reader 50 by sliding over the fingerprint scanner 52. While depicted as a notebook computer, the host device 60 may be any general purpose computing device, such as a PC, or a specialized device.

Computing devices such the host device 60, the data storage units 20, 20′, etc., may employ any of a number of computer and embedded operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices such the host device 60, the data storage units 20, 20′, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium, such as the storage mediums 26, 42, includes any medium that participates in providing data (e.g., instructions), which may be read by a computer. Such a medium may take many forms, including, but not limited to, non-volatile media, and volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

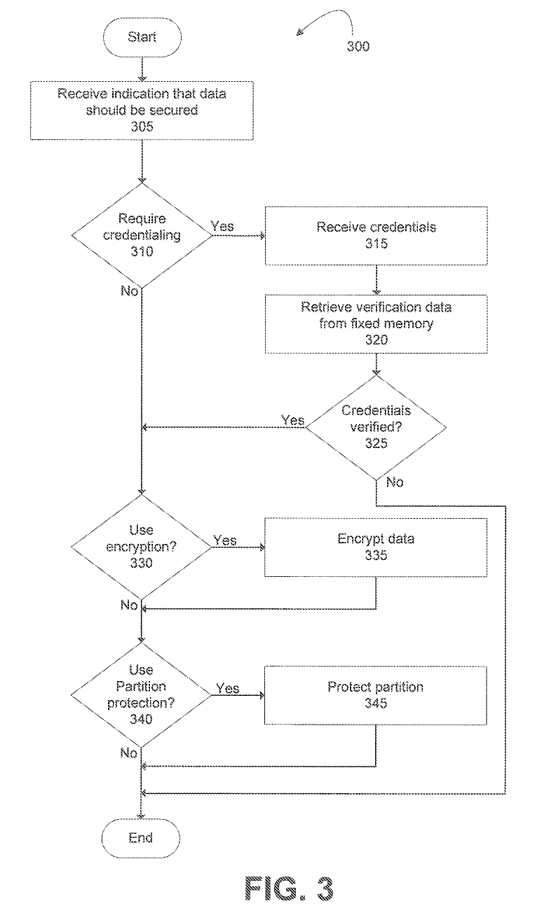

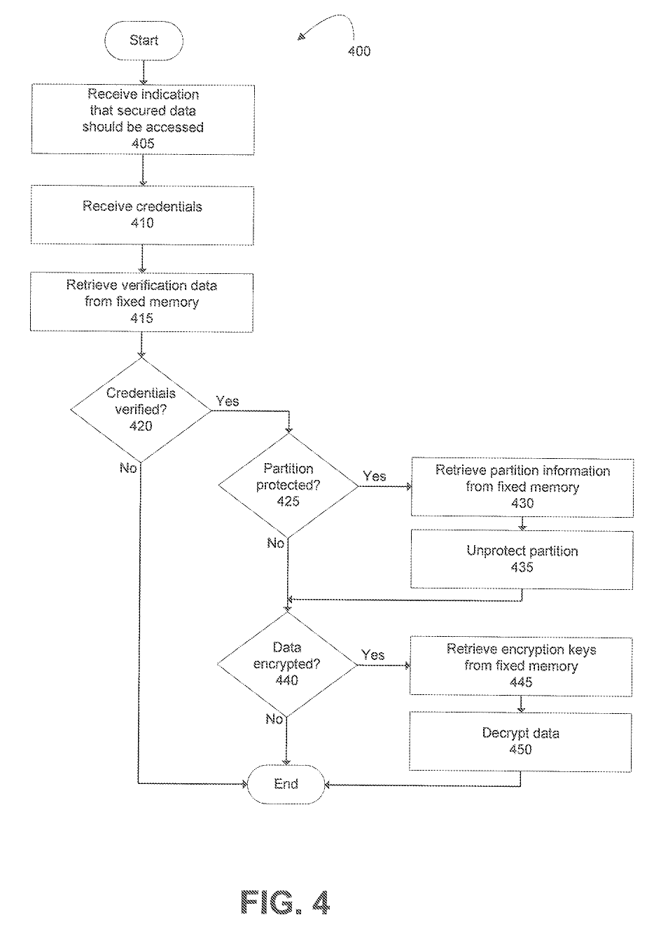

As discussed above, the data security module 28 may implement various techniques to secure the data of the data storage device 20. In one exemplary approach, the fixed storage medium 26 may remain unsecured while data on the removable flash memory card 40 may be secured. Data may be secured with encryption, partition protection techniques, or both. When both partition protection and encryption techniques are used, the order may be relevant. For example, a process of accessing secured data 400 (FIG. 4) may be the inverse of a process for securing the data 300 (FIG. 3). Additionally, if the data security module 28 is configured to encrypt individual files rather than the entire storage medium 42, the encryption technique may need to be implemented before the partition protection technique.

FIG. 3 illustrates a flowchart of an exemplary process 300 for securing data on a data storage unit 20 including a removable flash memory card 40. The data storage unit 20 may include a computer-readable medium having stored instructions for carrying out certain operations described herein, including some or all of the operations described with respect to process 300. For example, some or all of such instructions may be included in the data security module 28. Some steps of process 300 may include user input and interactions. However, it is to be understood that fully automated or other types of programmatic techniques may implement steps that include user input.

Process 300 begins in step 305, when an indication that data should be secured is received. For example, the device interface module 64 may communicate with the data security module 28 to indicate that data should be secured. An operator may be providing user input in a graphical user interface provided by the device interface module 64. In another exemplary approach, the data security module 28 may be configured to secure data on a regular basis, such as after a period of inactivity. In yet another exemplary approach, the data security module 28 may be configured to automatically secure data when the data storage unit 20 is disassociated or decoupled from the host device 60.

Next, in step 310, it may be determined whether credentialing is required prior to securing data. In one exemplary approach, the data security module may require credentialing to reduce the likelihood of inappropriately or inadvertently securing data. Additionally, credentialing may have previously occurred and therefore may not need to be conducted again. For example, a previously conduced credentialing may be sufficient for a predetermined period of time.

If credentialing is required, credentials may be received in step 315. In one exemplary approach using the biometric reader 50, the operator may be prompted to submit to a fingerprint scan using the scanner 52. The controller 24 may operate the scanner to create the fingerprint scan. If necessary, the fingerprint scan may then be converted into a derivative form for comparison. In another exemplary approach using password credentialing, the device interface module 64 may prompt the operator to enter a password. In another exemplary approach using digital certificate credentialing, a certificate may be transferred from the host device 60 to the data storage unit 20.

Next, in step 320, verification data may be retrieved from the fixed storage medium 26. As discussed above, storing the verification data in the fixed storage medium 26 may facilitate the use of the data storage unit 20 with a plurality of host devices, including host devices that have not been specially configured to work with the data storage unit 20. In an exemplary approach using biometric credentialing, a previously recorded fingerprint template may be retrieved from the fixed storage medium 26. Similarly, in other exemplary approaches the verification data such as a previously stored password or digital certificate may be retrieved from the fixed storage medium 26.

Next, in step 325, it may be determined whether the credentials are verified. Verifying the credentials may include a comparison of the credentials received in step 315 to the previously stored credentials that were retrieved in step 320. The determination may be based on an exact match of the credentials, or may be based on a degree of correspondence exceeding a threshold value. If the credentials are not verified, the process may end.

In step 330, it may be determined whether encryption should be used. As discussed above, the order of encryption and partition protection techniques may very based on the type of encryption used. If the entire storage medium 42 is encrypted, the partition protection may need to occur prior to the encryption. However, if only individual files are encrypted, then the encryption may occur prior to the partition protection. The determination of whether to use encryption may be based on user input or may be an automatic determination. For example, the operator may be prompted for user input regarding whether encryption should be used. However, other exemplary approaches may be configured to automatically use encryption for all files, particular files, particular file types, etc. If encryption is not used, the process may skip to step 340.

In step 335, the data may be encrypted. Encryption generally transforms data in a reversible manner using an algorithm and an encryption key. A complementary decryption algorithm may be used with the encryption key to restore the data. Accordingly, the encryption key may need to be available to decrypt the data. In one exemplary approach, the encryption key may be stored on the fixed storage medium 26. The encryption of the data may be conducted by the host device 60 given that it may possess significantly more processing power than the controller 24. However, other exemplary approaches may include a controller 24 with sufficient processing power to execute the encryption algorithm.

In step 340, it may be determined whether the partition should be protected. As discussed above, the operator may be presented with an interface to provide user input. In another exemplary approach, the use of a partition protection technique may automatically occur after particular events (e.g., the data storage unit 20 being disassociated with the host device 60), or may be based on a previously established preference or convention. If partition protection is not used, the process may end.

In step 345, the partition may be protected. As discussed above, there may be numerous ways to protection the partition. In one exemplary approach, the controller 24 may only allow read-only access to the storage medium 42. In another exemplary approach, the controller 24 may hide the storage medium 42 from the host device 60. In yet another exemplary approach, the file system of the storage medium 42 may be altered or corrupted in a reversible manner to render it unusable by the host device 60. Information necessary to reverse a partition protection technique may be stored on the fixed medium 26.

Following step 345, or a determination in step 340 that partition protection is not to be used, process 300 ends.

FIG. 4 illustrates a flowchart of an exemplary process 400 for accessing secured data. Process 400 may present inverse operations to the steps presented above in process 300. The data storage unit 20 may include a computer-readable medium having stored instructions for carrying out certain operations described herein, including some or all of the operations described with respect to process 400. For example, some or all of such instructions may be included in the data security module 28. Some steps of process 400 may include user input and interactions. However, it is to be understood that fully automated or other types of programmatic techniques may implement steps that include user input.

Process 400 begins in step 405 when an indication that secured data should be accessed is received. The operator may provide the indication through the device interface module 64. In another exemplary approach, the indication may be provided automatically based on the occurrence of an event such as the association of the data storage unit 20 with the host device 60.

Next in steps 410-420, credentials may be received and verified. Steps 410-420 may respectively correspond to steps 315-325 discussed above.

In step 425, it may be determined whether the partition is protected. In one exemplary approach, the controller 24 may analyze the removable storage medium 42 for indications that the partition is protected. In another exemplary approach, the fixed storage medium may include an indication that the removable storage medium is protected. If the partition is not protected, the process may skip to step 440.

In step 430, partition restoration information may be retrieved from the fixed storage medium 42. For example, if the file system was altered or corrupted in a reversible manner, the partition restoration information may include the original data and corresponding memory locations in which the original data should be written. In another exemplary approach using a data transformation algorithm (XOR, bit rotation, etc.) to alter the file system, the data transformation or offset may be stored on the fixed storage medium.

Next, in step 435, the partition may be unprotected using the information retrieved in step 430. The data security module 28 may execute a complementary algorithm using the restoration information to restore the partition to a usable or original state. In another exemplary approach, the controller 28 may reveal the existence of the removable storage medium 42 to the host device 60. Similarly, the controller 24 may allow data to be written to the removable storage medium 42.

In step 440, it may be determined whether the data is encrypted. As discussed above in step 425, the data on the removable storage medium may be analyzed to determine whether it is encrypted. In another exemplary approach, a record indicating that the data is encrypted may be stored on the fixed storage medium 26.

In step 445, the data encryption keys may be retrieved from the fixed memory. As discussed above, the fixed memory may include different encryption keys for different removable flash memory cards 40. Similarly, different encryption keys may be used for different portions of data. Additionally, multiple operators may use the same data storage unit 20 while maintaining different encryption keys. Accordingly, associations between the encrypted data the corresponding encryption keys may also be stored.

In step 450, the encrypted data may be decrypted using the encryption key retrieved in step 445. In one exemplary approach, the data may be transferred to the host device 60 to take advantage of superior processing power and then transferred back to the removable storage medium. In another exemplary approach, the controller 24 may conduct the decryption without transferring the data to the host device.

Following step 450 as well as determinations that the credentials were not verified in step 420 and that the data is not encrypted in step 440, process 400 ends.

Accordingly, a data storage unit 20 with upgradeable capacity includes a fixed storage medium 24 and a socket 30 for receiving a removable storage medium 42. A controller may interface with a host device 60 for accessing the storage mediums 26, 42. The socket 30 may include leads 34 configured to connect to the contacts 44 of a standardized flash memory card 40. A data security module 28 may include instructions for securing data stored on the removable storage medium 42 with encryption and partition protection techniques. Encryption keys and partition restoration information may be stored on the fixed storage medium 26 to facilitate the portability and interoperability of the data storage unit 20. Credentialing techniques, such as the use of a biometric reader 50, may prevent improper access to the encryption keys and partition restoration information.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A digital data storage device comprising:
a fixed storage medium;
an expansion socket configured to selectively receive at least one removable memory card; and
a controller configured to interface said fixed storage medium and said at least one removable memory card with a host device.

2. A digital data storage device of claim 1, wherein said at least one removable flash card includes a removable storage medium removable relative to said fixed storage medium.

3. A digital data storage device of claim 2, wherein said controller includes a data security module configured to secure data on said removable storage medium.

4. A digital data storage device of claim 3, wherein said data security module is configured to encrypt data on at least one of said fixed storage medium and said removable storage medium.

5. A digital data storage device of claim 3, wherein said controller is configured to apply at least one partition protection technique to said removable storage medium.

6. A digital data storage device of claim 5, wherein said removable storage medium includes a file system, and wherein the at least one partition protection technique includes selectively corrupting and restoring said file system.

7. A digital data storage device of claim 5, wherein said removable storage medium includes a file system, and wherein the at least one partition protection technique includes reversibly corrupting at least a portion of said file system.

8. A digital data storage device of claim 5, wherein said data security module is configured to store instructions for implementing the at least one partition protection technique.

9. A digital data storage device of claim 3, wherein said data security module is configured to implement a credentialing technique to verify an identity of an operator.

10. A digital data storage device of claim 9, further comprising a biometric reader configured to receive biometric information, and wherein said data security module verifies the identity of the operator based on at least the biometric information received from said biometric reader.

11. A method comprising:
verifying credentials with verification data stored on a fixed storage medium of a data storage unit; and
protecting data on a removable storage medium removably attached to the data storage unit.

12. A method as set forth in claim 11, further comprising storing an encryption key in the fixed storage medium.

13. A method as set forth in claim 12, wherein protecting data on the removable storage medium includes encrypting the data on the removable storage medium with an algorithm and the encryption key.

14. A method as set forth in claim 13, wherein encrypting the data includes reversibly encrypting the data on the removable storage medium with an algorithm and the encryption key.

15. A method as set forth in claim 13, further comprising decrypting the data using a complementary decryption algorithm.

16. A method as set forth in claim 11, wherein protecting data on the removable storage medium includes applying at least one partition protection technique to the removable storage medium.

17. A method as set forth in claim 16, wherein applying the at least one partition protection technique includes selectively corrupting and restoring a file system of the removable storage medium.

18. A method as set forth in claim 16, wherein applying the at least one partition protection technique includes reversibly corrupting a critical area of the storage medium used by a file system.

19. A method as set forth in claim 16, further comprising storing partition recovery information on the fixed storage medium.

20. A method as set forth in claim 11, wherein verifying credentials includes:
prompting a user for the verification data; and
comparing the verification data received from the user with the verification data stored in the fixed storage medium.

21. A method as set forth in claim 20, wherein the verification data includes at least one of biometric information from a biometric reader, a password, and a digital certificate.

22. A method as set forth in claim 11, further comprising accessing the protected data stored on the removable storage medium.

23. A method as set forth in claim 22, wherein accessing the protected data includes:
retrieving partition restoration information from the fixed storage medium if a partition protection technique has been applied to the removable storage medium; and
executing a complementary algorithm using the restoration information.

24. A method as set forth in claim 22, wherein accessing the protected data includes:
retrieving decryption keys from the fixed memory medium if the removable storage medium has been encrypted; and
decrypting the removable storage medium using the decryption keys.
